(19) United States
(12) Patent Application Publication
(10) Pub. No.: US 2015/0103801 A1
(43) Pub. Date: Apr. 16, 2015

(54) METHOD AND APPARATUS FOR TRANSMITTING SIGNAL FOR DOWNLINK CHANNEL ESTIMATION

(71) Applicants: Electronics and Telecommunications Research Institute, Daejeon (KR); Kongju National University Industry Academia Cooperation Group, Gongju-si Chungcheongnam-do (KR)

(72) Inventors: Junyoung Nam, Daejeon (KR); Bangwon Seo, Cheonan-si Chungcheongnam-do (KR); Jae Young Ahn, Daejeon (KR)

(21) Appl. No.: 14/474,932

(22) Filed: Sep. 2, 2014

(30) Foreign Application Priority Data
Sep. 2, 2013 (KR) 10-2013-0105062
Aug. 28, 2014 (KR) 10-2014-0113477

(51) Int. Cl. H04L 5/00

(52) U.S. Cl. CPC H04L 5/0048; H04L 5/0005
USPC 370/330

(57) ABSTRACT

A method and apparatus for transmitting a signal for channel estimation through a plurality of antennas are provided. A plurality of resources that are adjacent to each other in a time axis and a frequency axis are selected from among a set of resources that include a symbol in the time axis and a subcarrier in the frequency axis. Reference signals for the plurality of antennas are transmitted through the selected plurality of resources.

### CROSS-REFERENCE TO RELATED APPLICATION

This application claims priority to and the benefit of Korean Patent Application No. 10-2013-0105062 and No. 10-2014-0113477 filed in the Korean Intellectual Property Office on Sep. 2, 2013 and Aug. 28, 2014, the entire contents of which are incorporated herein by reference.

### BACKGROUND OF THE INVENTION

(a) Field of the Invention

The present invention relates to a method and apparatus for transmitting a signal. More particularly, the present invention relates to a method and apparatus for transmitting a signal for estimating a downlink channel.

(b) Description of the Related Art

When transmitting a packet in a wireless communication system, distortion of a signal may occur while transmitting since the packet is being transmitted through a radio channel. By transmitting a signal that both of a transmitting end and a receiving end knows, the information of a channel may be obtained based on the distortion of the signal. Here, the signal that both of them knows can be referred to as a pilot signal or a reference signal. To improve the efficiency of transmitting/receiving with multiple transmitting antennas or multiple receiving antennas, reference signals by transmitting antennas should exist. The reference signal may be classified as a reference signal for obtaining channel information or a reference signal for data demodulation.

The reference signal for data demodulation is transmitted along with downlink data by a base station, and a terminal estimates a channel with the reference signal to demodulate the downlink data.

For a unicast service in a long term evolution (LTE) system, the reference signal may be classified as a common reference signal (CRS) for obtaining information of channel state and measuring for handover, or a dedicated reference signal (DRS) for data demodulation. The DRS is used for data demodulation and the CRS is used for obtaining channel information and for data demodulation.

For smooth operation of a terminal in an LTE-A system, the reference signal has to be defined for a maximum of eight transmitting antenna ports in the time-frequency domain in which the CRS of the LTE system is transmitted. The reference signal in the LTE-A system is generally a channel state information reference signal (CSI-RS) for channel measurement and a demodulation reference signal (DM-RS) for demodulation data transmitted through eight antennas.

The CSI-RS is designed for the sake of measuring to estimate a channel, while the CRS is used for measuring to estimate a channel and to perform a handover, as well as for data demodulation. The CSI-RS is transmitted for obtaining information on a channel state, and thereby it does not need to be transmitted every subframe, unlike the CRS.

### SUMMARY OF THE INVENTION

The present invention has been made in an effort to provide a method and apparatus for transmitting a reference signal to efficiently estimate a channel.

An exemplary embodiment of the present invention provides a method of transmitting a signal for channel estimation through a plurality of antennas. The method includes: selecting a plurality of resources that are adjacent to each other in a time axis and a frequency axis, from among a set of resources that include a symbol in the time axis and a subcarrier in the frequency axis; and transmitting reference signals for the plurality of antennas through the selected plurality of resources.

The transmitting of reference signals may include distinguishing a reference signal for each transmitting antenna by multiplying a two-dimensional orthogonal code by each of the reference signals.

The selecting of a plurality of resources may include selecting a plurality of pairs of resources from the set of resources when a number of the transmitting antennas is more than a predetermined number, wherein four resources that are adjacent to each other in the time axis and the frequency axis are referred to as a pair of resources.

The selecting of a plurality of resources may include selecting a plurality of pairs of resources by selecting resources corresponding to two neighboring subcarriers in the frequency axis from among resources corresponding to two symbols that are adjacent to each other.

The transmitting of reference signals may include distinguishing a reference signal for each transmitting antenna by multiplying a two-dimensional orthogonal code by each of the reference signals transmitted through one pair of resources.

The transmitting of reference signals may include distinguishing a reference signal for each transmitting antenna by multiplying a one-dimensional orthogonal code with a length of 2 by each of the reference signals transmitted through one pair of resources.

The selecting of a plurality of resources may include selecting a plurality of pairs of resources by selecting resources corresponding to two neighboring subcarriers in the frequency axis from among resources corresponding to pairs of symbols that are adjacent to each other in the time axis.

The selecting of a plurality of resources may include selecting a plurality of pairs of resources by using a scheme that forms a first pair of resources by selecting resources corresponding to two neighboring subcarriers in the frequency axis from among resources corresponding to a first pairs of symbols in which a first symbol and a second symbol are adjacent to each other in the time axis and a second pair of resources by selecting resources corresponding to two neighboring subcarriers in the frequency axis from among resources corresponding to a second pairs of symbols in which a third symbol and a fourth symbol are adjacent to each other in the time axis.

Here, the pairs of symbols may not neighbor each other.

The transmitting of reference signals may include distinguishing reference signals transmitted through one pair of resources by transmitting antennas by multiplying a two-dimensional orthogonal code by each of the reference signals transmitted through the pair of resources.

The transmitting of reference signals may include distinguishing reference signals transmitted through one pair of resources by transmitting antennas by multiplying an orthogonal code with a length of 2 in the time axis by each of the reference signals transmitted through the pair of resources.

Another embodiment of the present invention provides an apparatus for transmitting a signal for channel estimation through a plurality of antennas. The apparatus includes: a radio frequency converter for transmitting and receiving a signal through the plurality of antennas; and a processor that is connected to the radio frequency converter and controls transmitting for a reference signal for channel estimation, wherein the processor includes a resource selector that selects a plurality of resources that are adjacent to each other in a time axis and a frequency axis, from among a set of resources that include a symbol in the time axis and a subcarrier in the frequency axis, and an orthogonal code applier that applies an orthogonal code to each of reference signals for the plurality of antennas transmitted through the selected plurality of resources.

When four resources that are adjacent to each other in the time axis and the frequency axis are referred to as a pair of resources, the orthogonal code applier may distinguish a reference signal for each transmitting antenna by multiplying a two-dimensional orthogonal code by each of the reference signals transmitted through one pair of resources.

When a number of the transmitting antenna is more than a predetermined number, the resource selector may select a plurality of pairs of resources by selecting resources corresponding to two neighboring subcarriers in the frequency axis from among resources corresponding to two symbols that are adjacent to each other in the time axis.

The resource selector may select a plurality of pairs of resources by selecting resources corresponding to two neighboring subcarriers in the frequency axis from among resources corresponding to pairs of symbols in which two symbols are adjacent to each other in the time axis.

When four resources that are adjacent to each other in the time axis and the frequency axis are referred to as a pair of resources, the orthogonal code applier may distinguish a reference signal for each transmitting antenna by multiplying a one-dimensional orthogonal code with a length of 2 by each of the reference signals transmitted through one pair of resources.

When a number of the transmitting antennas is more than a predetermined number, the resource selector may select a plurality of pairs of resources by selecting resources corresponding to two neighboring subcarriers in the frequency axis from among resources corresponding to two symbols that are adjacent to each other in the time axis.

The resource selector may select a plurality of pairs of resources by selecting resources corresponding to two neighboring subcarriers in the frequency axis from among resources corresponding to pairs of symbols in which two symbols are adjacent to each other in the time axis.

### BRIEF DESCRIPTION OF THE DRAWINGS

FIG. 1 shows transmitting of a reference signal to estimate a channel in a wireless communication system according to an exemplary embodiment of the present invention.

FIG. 2 shows a process for transmitting different reference signals using an orthogonal code according to an exemplary embodiment of the present invention.

FIG. 3 shows a construction of resources for reference signal transmission according to the first exemplary embodiment of the present invention.

FIG. 4 shows an example of transmitting reference signals with 4 resources that are adjacent to each other on a time axis and a frequency axis according to the first exemplary embodiment of the present invention.

FIG. 5 shows a process for multiplying two-dimensional orthogonal codes by reference signals and transmitting them according to the first exemplary embodiment of the present invention.

FIG. 6 shows a process for multiplying two-dimensional orthogonal codes by reference signals and transmitting them according to the second exemplary embodiment of the present invention

FIG. 7 shows a process for transmitting a reference signal by multiplying a two-dimensional orthogonal code by the reference signal according to the third exemplary embodiment of the present invention.

FIG. 8 shows an example of transmitting a reference signal according to the third exemplary embodiment of the present invention.

FIG. 9 shows a process of transmitting a reference signal according to the fourth exemplary embodiment of the present invention.

FIG. 10 shows a flowchart of transmitting a reference signal according to an exemplary embodiment of the present invention.

FIG. 11 shows a structure of a signal transmitting apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification, in addition, unless explicitly described to the contrary, the word “comprise” and variations such as “comprises” or “comprising” will be understood to imply the inclusion of stated elements but not the exclusion of any other elements.

In this specification, a terminal may designate a mobile terminal (MT), a mobile station (MS), an advanced mobile station (AMS), a high reliability mobile station (HR-MS), a subscriber station (SS), a portable subscriber station (PSS), an access terminal (AT), user equipment (UE), etc., and may include the entire or partial functions of the MT, the MS, the AMS, the HR-MS, the SS, the PSS, the AT, the UE, etc. A base station (BS) may designate an advanced base station (ABS), a high reliability base station (HR-BS), a node B (nodeB), an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (HR-RS) serving as a base station, a high reliability relay station (HR-RS) serving as a base station, a small base station (a femto BS, a home node B (HNB), a home eNodeB (HeNB), a pico BS, a metro BS, a micro BS, etc.), etc., and may include all or some functions of the ABS, the nodeB, the eNodeB, the AP, the RAS, the BTS, the MMR-BS, the RS, the RN, the ARS, the HR-RS, the small base station, etc.

Hereinafter, a method and apparatus for transmitting a signal for estimating a downlink channel according to an exemplary embodiment of the present invention will be described.

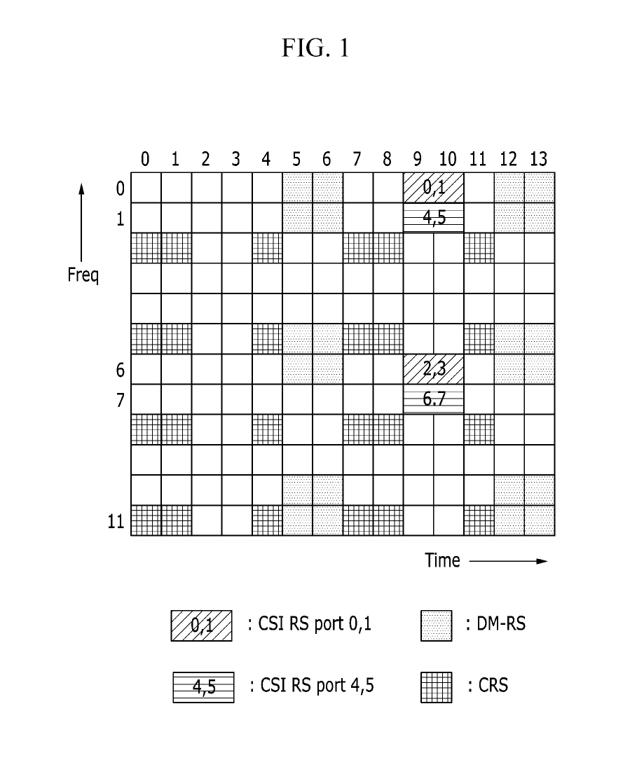

FIG. 1 shows transmitting of a reference signal to estimate a channel in a wireless communication system according to an exemplary embodiment of the present invention.

In a wireless communication system (e.g., the third generation partnership project long term evolution/long term evolution advanced (3GPP LTE/LTE-A) system), a reference signal is transmitted to estimate a channel state. A channel state information-reference signal (CSI-RS) may be transmitted as the reference signal. The reference signals (CSI_RS) for estimating a channel state of a plurality of transmitting antennas (e.g., a maximum of 8 antennas) may be transmitted through a resource block (RB) as shown in FIG. 1.

FIG. 1 shows an example of transmitting reference signals (CSI-RS) for 8 transmitting antennas. The resource block represents a set of resources that consist of 12 subcarriers and 12 or 14 orthogonal frequency division modulation (OFDM) symbols. If there are 8 transmitting antenna ports, for convenience of explanation, the transmitting antenna ports may be referred as to “0, 1, 2, . . . , 7”. A resource element consisting of a subcarrier A and an OFDM symbol B may be represented as “RE(A,B)”. As shown in FIG. 1, to transmit reference signals (CSI-RS) for the transmitting antenna ports 0 and 1, two resources RE(0,9) and RE(0,10) are used. Since the reference signals (CSI-RS) for the transmitting antenna ports 0 and 1 are transmitted through the same resources, one-dimensional orthogonal codes with a length of 2 in a time axis are multiplied to distinguish the reference signals (CSI-RS). That is, an orthogonal code of [1, 1] is multiplied by the reference signal (CSI-RS) for the transmitting antenna port 0, and an orthogonal code of [1, −1] is multiplied by the reference signal (CSI-RS) for the transmitting antenna port 1.

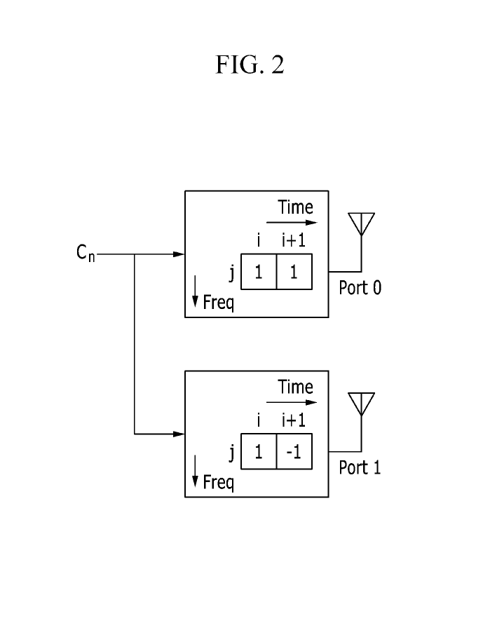

FIG. 2 shows a process for transmitting different reference signals using an orthogonal code according to an exemplary embodiment of the present invention.

In FIG. 2, i represents the i-th OFDM symbol and j represents the j-th subcarrier. cₙ represents a sequence of a CSI-RS in the n-th RB, and has a value of +D or −D. Here, D represents an integer.

A base station as described above transmits reference signals (CSI-RS) for two antenna ports through two resources (RE) which are adjacent to each other on a time axis, and multiplies orthogonal codes with a length of 2 by the reference signals in the time axis to distinguish the reference signals.

Meanwhile, in FIG. 1, for example, looking at the OFDM symbol 9, a reference signal (CSI-RS) for the transmitting antenna port 0 is transmitted through the subcarrier 0 in a resource block (RB) and is not transmitted through the subcarriers 4, 6, and 7. When the reference signal (CSI-RS) for the transmitting antenna port 0 is transmitted through the resources RE(0,9) and RE(0,10), it has transmitting power four times higher than that of the others so that the sum of transmitting power for each transmitting antenna port is the same for each OFDM symbol. In the same manner, the reference signal (CSI-RS) for the transmitting antenna port 1 is transmitted with four times higher transmission power through the resources RE(0,9) and RE(0,10), and the reference signal (CSI-RS) for the transmitting antenna port 4 is transmitted with four times higher transmission power through the resources RE(1,9) and RE(1,10).

For efficient reference signal transmission in an exemplary embodiment of the present invention, a plurality of reference signals are transmitted by using a plurality of resources that are adjacent to each other on a time axis and a frequency axis, and orthogonal codes are multiplied by the plurality of reference signals to distinguish signals.

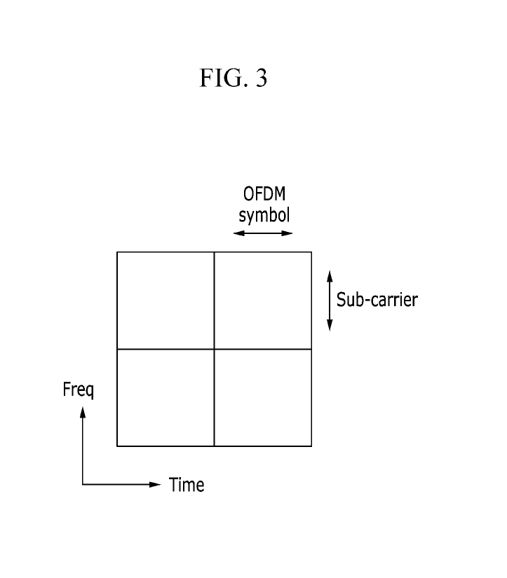

FIG. 3 shows a construction of resources for reference signal transmission according to the first exemplary embodiment of the present invention.

In the first exemplary embodiment of the present invention, by using a plurality of resources (e.g., minimum 4) that are adjacent to each other on a time axis and a frequency axis, the reference signals (CSI-RS) for transmitting antenna ports (e.g., 8 ports) are transmitted.

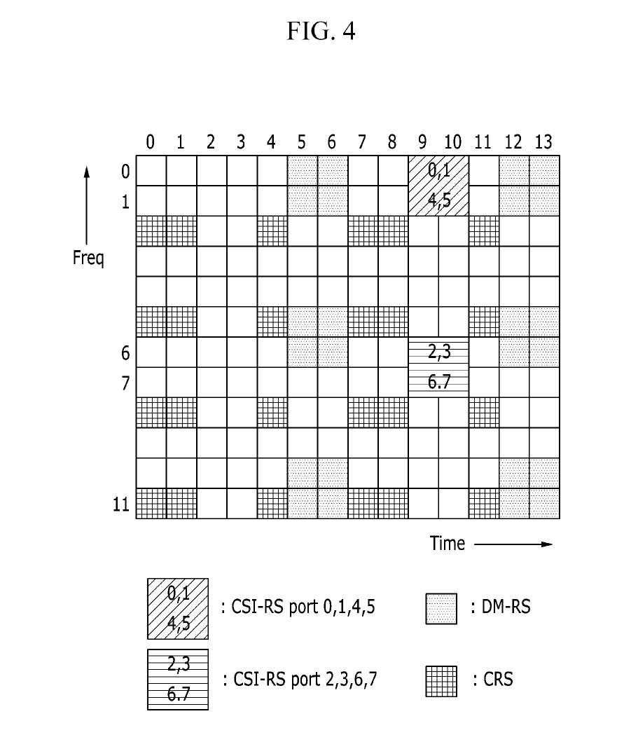

FIG. 4 shows an example of transmitting reference signals with 4 resources that are adjacent to each other on a time axis and a frequency axis according to the first exemplary embodiment of the present invention.

As shown in FIG. 4, when transmitting reference signals (CSI-RS) for 8 transmitting antenna ports, the reference signals (CSI-RS) for transmitting antenna ports 0, 1, 4, and 5 are transmitted by using 4 resources RE(0,9), RE(0,10), RE(1,9), and RE(1,10) that are adjacent to each other on a time axis and a frequency axis, and the reference signals (CSI-RS) for the remaining transmitting antenna ports 2, 3, 6 and 7 are transmitted by using 4 resources RE(6,9), RE(6,10), RE(7,9), and RE(7,10) that are adjacent to each other on a time axis and a frequency axis. Two-dimensional orthogonal codes with a length of 2 in a time axis and a length of 2 in a frequency axis are multiplied by the reference signals to be distinguished to each transmitting antenna port.

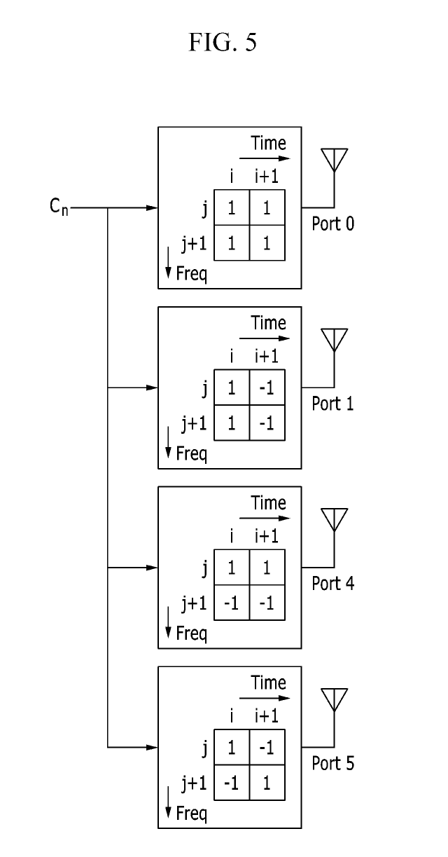

FIG. 5 shows a process for multiplying two-dimensional orthogonal codes by reference signals and transmitting them according to the first exemplary embodiment of the present invention.

Here, i represents the i-th OFDM symbol and j represents the j-th subcarrier. There is orthogonality between the neighboring resources on a time axis for the transmitting antenna ports 0 and 1, and there is orthogonality between the neighboring resources on a time axis for the transmitting antenna ports 4 and 5. In addition, there is two-dimensional orthogonality between the transmitting antenna ports 0 and 1 and the transmitting antenna ports 4 and 5.

Meanwhile, in an exemplary embodiment of the present invention, reference signals can be transmitted for 8 or more transmitting antenna ports.

To transmit reference signals for 8 or more transmitting antenna ports, first, they are transmitted through two adjacent OFDM symbol intervals. At this time, by transmitting reference signals (CSI-RS) with two-dimensional orthogonal codes according to an exemplary embodiment of the present invention, reference signals (CSI-RS) for 8 or more transmitting antenna ports are transmitted through two adjacent OFDM symbol intervals.

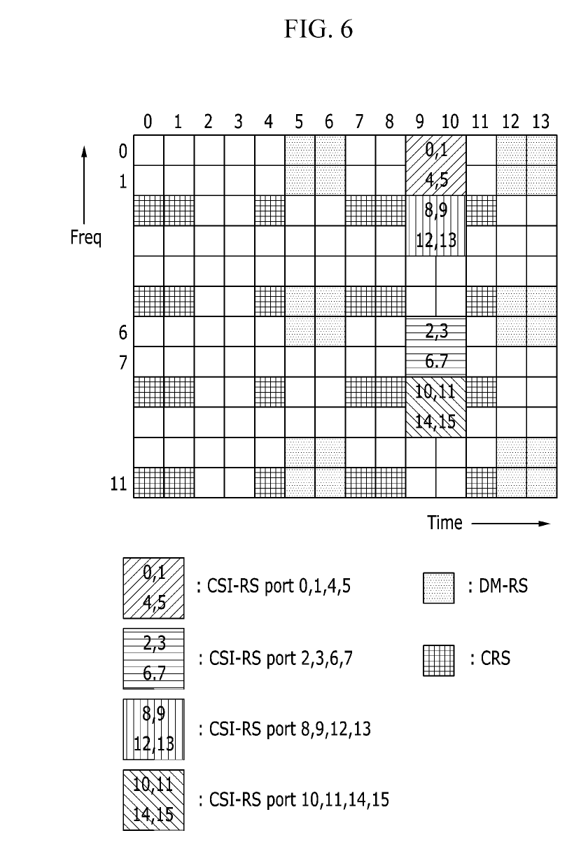

FIG. 6 shows a process for multiplying two-dimensional orthogonal codes by reference signals and transmitting them according to the second exemplary embodiment of the present invention

FIG. 6 shows an example of transmitting reference signals (CSI-RS) for 16 or more transmitting antenna ports through two adjacent OFDM symbol intervals.

To transmit reference signals for 16 or more transmitting antenna ports, as shown in FIG. 6, two OFDM symbols on a time axis and 8 subcarriers on a frequency axis are used. At this time, reference signals (CSI-RS) for 4 transmitting antenna ports are transmitted through resources that are adjacent to each other in a time axis and a frequency axis, and two-dimensional orthogonal codes are multiplied by the reference signals (CSI-RS) to distinguish transmitting antenna ports. Here, when selecting 8 subcarriers, a pair of neighboring subcarriers may be selected so that four pairs are obtained.

For example, regarding the OFDM symbol 9, the reference signal (CSI-RS) for the transmitting antenna port 0 is transmitted through the subcarriers 0 and 1 rather than the subcarriers 2, 3, 6, 7, 8, and 9. Accordingly, when the reference signal (CSI-RS) for the transmitting antenna port 0 is transmitted through the resources RE(0,9), RE(0,10), and RE(1,10), it has transmitting power four times higher than that of the others so that the sum of transmitting power for each transmitting antenna port is the same for each OFDM symbol. That is, when transmitting reference signals (CSI-RS) for 16 transmitting antenna ports with neighboring OFDM symbols, the reference signals (CSI-RS) are transmitted with power four times higher than that of the others at resources.

When transmitting reference signals for 12 transmitting antenna ports through two neighboring OFDM symbols, 6 subcarriers on the frequency axis are used. Here, when selecting the 6 subcarriers, a pair of neighboring subcarriers may be selected so that three pairs are obtained.

Meanwhile, to transmit reference signals (CSI-RS) for 8 or more transmitting antenna ports, secondly, they are transmitted through two or more OFDM symbols.

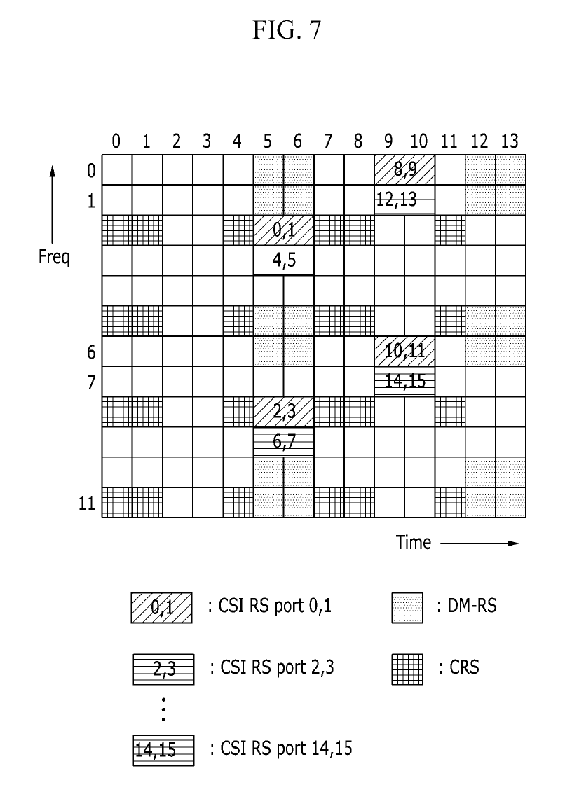

FIG. 7 shows a process for transmitting a reference signal by multiplying a two-dimensional orthogonal code by the reference signal according to the third exemplary embodiment of the present invention.

In FIG. 7, an example of a method that transmits reference signals (CSI-RS) for 16 transmitting antenna ports with 4 OFDM symbols is shown. Here, when 4 resources (RE) are adjacent to each other on a time axis and a frequency axis, one method of multiplying an orthogonal code is to multiply an orthogonal code with a length of 2 on the time axis. Another method of multiplying an orthogonal code is to multiply a two-dimensional orthogonal code according to an exemplary embodiment of the present invention. In FIG. 7, multiplying a one-dimensional orthogonal code with a length of 2 on the time axis by reference signals is shown.

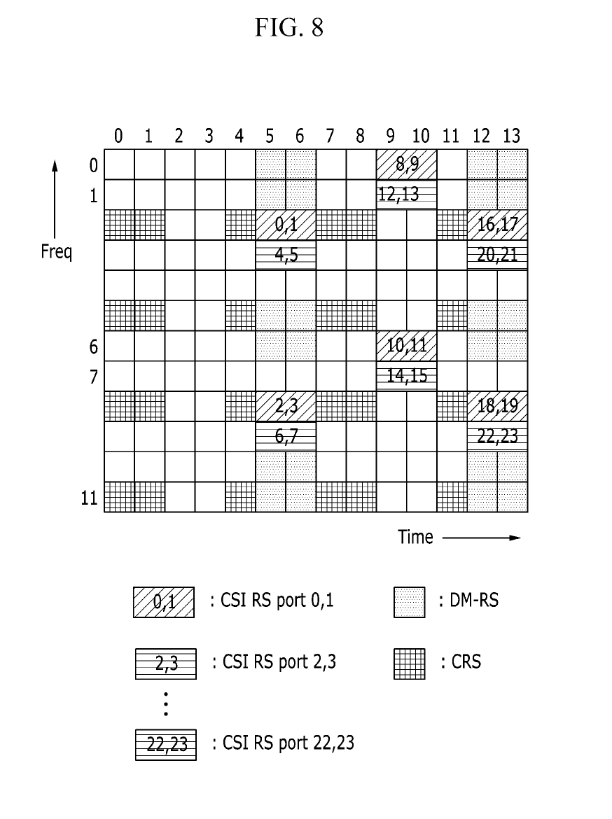

FIG. 8 shows an example of transmitting a reference signal according to the third exemplary embodiment of the present invention.

In FIG. 8, reference signals (CSI-RS) for 24 transmitting antenna ports with 6 OFDM symbols are transmitted. Here, a one-dimensional orthogonal code with a length of 2 on the time axis is multiplied by reference signals, but a two-dimensional orthogonal code can be multiplied by reference signals.

Meanwhile, to transmit reference signals (CSI-RS) for 8 or more transmitting antenna ports, thirdly, they are transmitted through the combination of the above-described two methods. That is, reference signals are transmitted with two or more OFDM symbols and the two-dimensional orthogonal code.

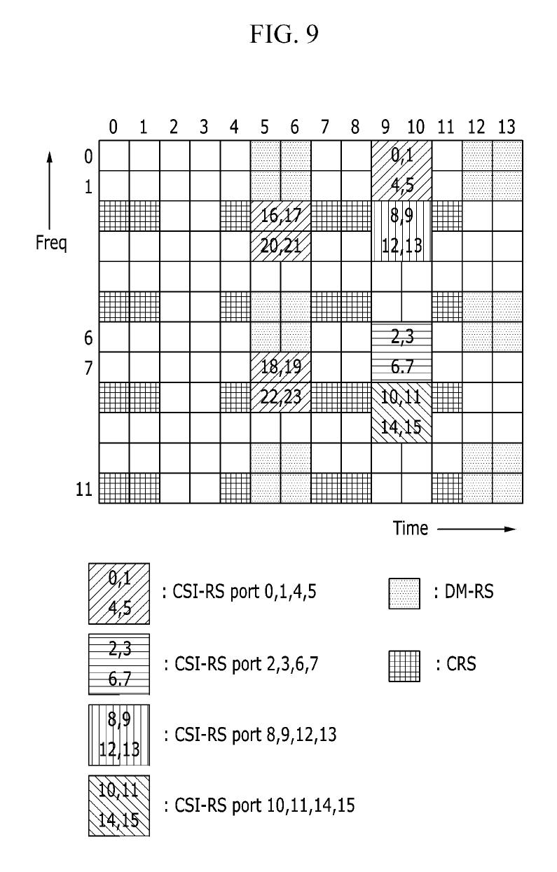

FIG. 9 shows a process of transmitting a reference signal according to the fourth exemplary embodiment of the present invention.

In FIG. 9, an example of transmitting reference signals (CSI-RS) for 24 transmitting antenna ports by using 4 OFDM symbols and two-dimensional orthogonal codes is shown. Here, when transmitting reference signals (CSI-RS) for 8 or more transmitting antenna ports through two neighboring OFDM symbols, the two-dimensional orthogonal code according to an exemplary embodiment of the present invention is applied.

Meanwhile, when transmitting reference signals (CSI-RS) for 8 or less transmitting antenna ports through two neighboring OFDM symbols, a one-dimensional orthogonal code according to an exemplary embodiment of the present invention is applied, and particularly, a one-dimensional orthogonal code with a length of 2 on the time axis is multiplied by the reference signals. Alternatively, two-dimensional orthogonal codes according to an exemplary embodiment of the present invention are multiplied by the reference signals.

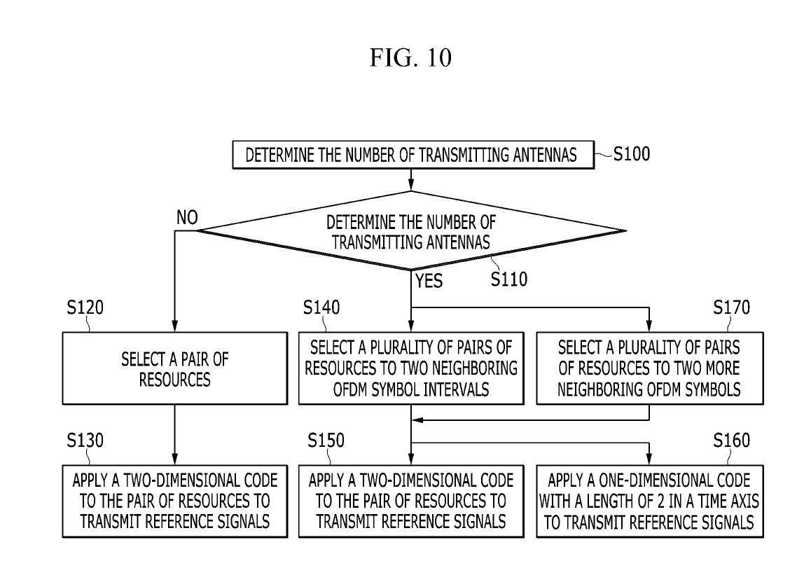

FIG. 10 shows a flowchart of transmitting a reference signal according to an exemplary embodiment of the present invention.

To transmit reference signals, from a set of resources in which a plurality of subcarriers are arranged in a frequency axis and a plurality of OFDM symbols are arranged in a time axis, resources for transmitting reference signals are selected based on the number of transmitting antenna ports.

Specifically, when a block of a symbol in the time axis and a subcarrier on the frequency axis is referred to a resource, a plurality of resources (e.g. 4 resources) which are adjacent to each other in the time axis and the frequency axis are selected from the set of resources. When the selected plurality of resources may be referred to as “a pair of resources” for convenience description, reference signals for a plurality of transmitting antennas (e.g. 4) are transmitted through a pair of resources. To distinguish the reference signals transmitted through a pair of resources, a two-dimensional orthogonal code or one-dimensional orthogonal code is multiplied by each of the reference signals.

At this time, a plurality of pairs of resources may be formed based on the number of the transmitting antenna ports.

The pair of resources according to an exemplary embodiment of the present invention includes resources of a predetermined number (e.g. 4), and a plurality of the pairs of resources are selected based on the number of transmitting antenna ports to select resources corresponding to the transmitting antenna ports (S100).

When the number of the transmitting antenna ports is the predetermined port number (e.g. 4), a pair of resources are selected from the set of resources, and reference signals are transmitted through the selected pair of resources (S110 and S120).

At this time, two-dimensional orthogonal codes are applied to the reference signals transmitted through the selected pair of resources to distinguish the reference signals for transmitting antenna ports (S130).

When the number of the transmitting antenna ports is more than that of the predetermined port number (e.g. 4), a plurality of the pairs of resources are selected from the set of resources. In this case, two neighboring OFDM symbols may be selected as a pair of resources (S140). That is, as shown in FIG. 4 and FIG. 6, a pair of resources are formed to the interval consisting of two neighboring OFDM symbols. For example, from resources corresponding to a first symbol and a second symbol, two resources corresponding to neighboring subcarriers are selected as a pair of resources to form a plurality of pairs of resources. The resources consisting of the pairs of resources correspond to the first symbol, the second symbol, and two further selected subcarriers, and they are adjacent to each other on the time axis and the frequency axis.

Reference signals are transmitted through the plurality of pairs of resources, and each of the reference signals for transmitting antenna ports is distinguished by applying two-dimensional orthogonal codes to them (S150). In addition, each of the reference signals for transmitting antenna ports may be distinguished by applying one-dimensional orthogonal codes with a length of 2 to them (S160).

Meanwhile, when selecting a plurality of pairs of resources, two more OFDM symbols are used in the selecting (S170). That is, as shown in FIG. 7 and FIG. 8, a pair of resources are formed with resources corresponding to a pair of symbols in which two symbols are adjacent to each other in the time axis. For example, to form a plurality of pairs of resources, two resources corresponding to neighboring subcarriers are selected as a pair of resources from resources corresponding to a first pair of symbols including a first symbol and a second symbol, and two resources corresponding to neighboring subcarriers are selected as a pair of resources from resources corresponding to a second pair of symbols including a third symbol and a fourth symbol. Here, the pairs of symbols may not be adjacent to each other. That is, the first pair of symbols may not be adjacent to the second pair of symbols. The resources included in a pair of resources correspond to two symbols and two selected subcarriers, and are adjacent to each other in the time axis and the frequency axis.

Reference signals are transmitted through the plurality of pairs of resources, and each of the reference signals for transmitting antenna ports is distinguished by applying two-dimensional orthogonal codes to them. In addition, each of the reference signals for transmitting antenna ports may be distinguished by applying one-dimensional orthogonal codes with a length of 2 to them.

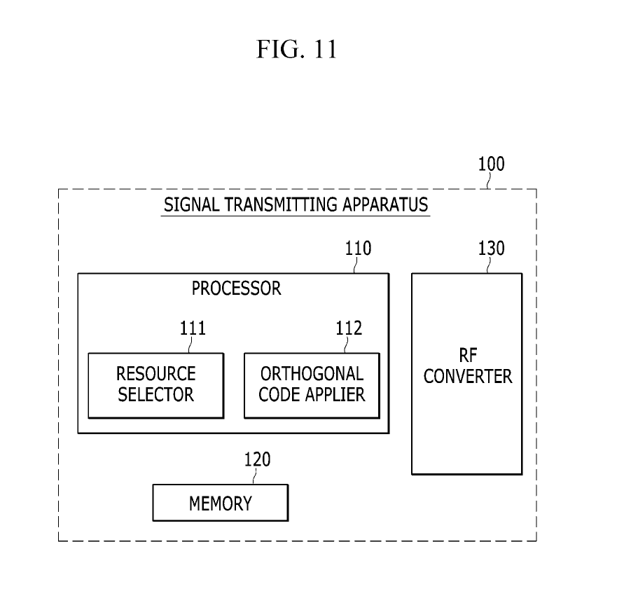

FIG. 11 shows a structure of a signal transmitting apparatus according to an exemplary embodiment of the present invention.

As shown in FIG. 11, the signal transmitting apparatus 100 includes a processor 110, a memory 120, and a radio frequency (RF) converter 130.

The processor 110 may be constructed to perform the above methods and process described based on FIG. 2 to FIG. 10.

For this purpose, the processor 110 includes a resource selector 111 and an orthogonal code applier 112.

The resource selector 111 selects, from a set of resources that include symbols in the time axis and subcarriers in the frequency axis, a plurality of resources (e.g. 4 resources) that are adjacent to each other on the time axis and the frequency axis.

The orthogonal code applier 112 multiplies one-dimensional code with a length of 2 in the time axis or a two-dimensional orthogonal code by each of reference signals to transmit the reference signals through the selected resources. The orthogonal code applier 112 may be embodied in the form as shown in FIG. 5.

The memory 120 is connected to the processor 110 and stores information on the operation of the processor 110. The RF converter 130 is connected to the processor 110 and transmits or receives a wireless signal, and particularly, transmits or receives a signal through multiple antennas.

According to an embodiment of the present invention, it is possible to efficiently transmit a reference signal for estimating a downlink channel state. Particularly, reference signals are transmitted such that channel state information for 8 or more transmitting antenna ports may be estimated.

The exemplary embodiments of the present invention may be implemented through the above-described apparatus and/or method, and may also be implemented with a program for realizing the functions corresponding to the elements of the exemplary embodiments of the present invention, and a recording medium storing the program. These implementations may be easily achieved from the description of the exemplary embodiments by a person of ordinary skill in the art. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of transmitting a signal for channel estimation through a plurality of antennas, the method comprising:
selecting a plurality of resources that are adjacent to each other in a time axis and a frequency axis, from among a set of resources that include a symbol in the time axis and a subcarrier in the frequency axis; and
transmitting reference signals for the plurality of antennas through the selected plurality of resources.

2. The method of claim 1, wherein the transmitting of reference signals includes distinguishing a reference signal for each transmitting antenna by multiplying a two-dimensional orthogonal code by each of the reference signals.

3. The method of claim 1, wherein the selecting of a plurality of resources includes selecting a plurality of pairs of resources from the set of resources when a number of the transmitting antennas is more than a predetermined number, wherein four resources that are adjacent to each other in the time axis and the frequency axis are referred to as a pair of resources.

4. The method of claim 3, wherein the selecting of a plurality of resources includes selecting a plurality of pairs of resources by selecting resources corresponding to two neighboring subcarriers in the frequency axis from among resources corresponding to two symbols that are adjacent to each other.

5. The method of claim 4, wherein the transmitting of reference signals includes distinguishing a reference signal for each transmitting antenna by multiplying a two-dimensional orthogonal code by each of the reference signals transmitted through one pair of resources.

6. The method of claim 4, wherein the transmitting of reference signals includes distinguishing a reference signal for each transmitting antenna by multiplying a one-dimensional orthogonal code with a length of 2 by each of the reference signals transmitted through one pair of resources.

7. The method of claim 3, wherein the selecting of a plurality of resources includes selecting a plurality of pairs of resources by selecting resources corresponding to two neighboring subcarriers in the frequency axis from among resources corresponding to pairs of symbols that are adjacent to each other in the time axis.

8. The method of claim 7, wherein the selecting of a plurality of resources includes selecting a plurality of pairs of resources by using a scheme that forms a first pair of resources by selecting resources corresponding to two neighboring subcarriers in the frequency axis from among resources corresponding to a first pairs of symbols in which a first symbol and a second symbol are adjacent to each other in the time axis and a second pair of resources by selecting resources corresponding to two neighboring subcarriers in the frequency axis from among resources corresponding to a second pairs of symbols in which a third symbol and a fourth symbol are adjacent to each other in the time axis.

9. The method of claim 7, wherein the pairs of symbols do not neighbor to each other.

10. The method of claim 7, wherein the transmitting of reference signals includes distinguishing reference signals transmitted through one pair of resources by transmitting antennas by multiplying a two-dimensional orthogonal code by each of the reference signals transmitted through the pair of resources.

11. The method of claim 7, wherein the transmitting of reference signals includes distinguishing reference signals transmitted through one pair of resources by transmitting antennas by multiplying an orthogonal code with a length of 2 in the time axis by each of the reference signals transmitted through the pair of resources.

12. An apparatus for transmitting a signal for channel estimation through a plurality of antennas, the apparatus comprising:
a radio frequency converter for transmitting and receiving a signal through the plurality of antennas; and
a processor that is connected to the radio frequency converter and controls transmitting for a reference signal for channel estimation,
wherein the processor includes a resource selector that selects a plurality of resources that are adjacent to each other in a time axis and a frequency axis, from among a set of resources that include a symbol in the time axis and a subcarrier in the frequency axis, and
an orthogonal code applier that applies an orthogonal code to each of reference signals for the plurality of antennas transmitted through the selected plurality of resources.

13. The apparatus of claim 12, wherein when four resources that are adjacent to each other in the time axis and the frequency axis are referred to as a pair of resources,
the orthogonal code applier distinguishes a reference signal for each transmitting antenna by multiplying a two-dimensional orthogonal code by each of the reference signals transmitted through one pair of resources.

14. The apparatus of claim 13, wherein when a number of the transmitting antenna is more than a predetermined number, the resource selector selects a plurality of pairs of resources by selecting resources corresponding to two neighboring subcarriers in the frequency axis from among resources corresponding to two symbols that are adjacent to each other in the time axis.

15. The apparatus of claim 13, wherein the resource selector selects a plurality of pairs of resources by selecting resources corresponding to two neighboring subcarriers in the frequency axis from among resources corresponding to pairs of symbols in which two symbols are adjacent to each other in the time axis.

16. The apparatus of claim 12, wherein when four resources that are adjacent to each other in the time axis and the frequency axis are referred to as a pair of resources,
the orthogonal code applier distinguishes a reference signal for each transmitting antenna by multiplying a one-dimensional orthogonal code with a length of 2 by each of the reference signals transmitted through one pair of resources.

17. The apparatus of claim 16, wherein when a number of the transmitting antenna is more than a predetermined number, the resource selector selects a plurality of pairs of resources by selecting resources corresponding to two neighboring subcarriers in the frequency axis from among resources corresponding to two symbols that are adjacent to each other in the time axis.

18. The apparatus of claim 16, wherein the resource selector selects a plurality of pairs of resources by selecting resources corresponding to two neighboring subcarriers in the frequency axis from among resources corresponding to pairs of symbols in which two symbols are adjacent to each other in the time axis.
